(19) United States
(12) Patent Application Publication
(10) Pub. No.: US 2005/0016671 A1
(43) Pub. Date: Jan. 27, 2005

(54) Robotic tape applicator and method

(76) Inventor: Terrance M. Sharp, Milton (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/826,506

(22) Filed: Apr. 19, 2004

Related U.S. Application Data
(63) Continuation-in-part of application No. 10/087,930, filed on Mar. 5, 2002.
(60) Provisional application No. 60/272,775, filed on Mar. 5, 2001.

(51) Int. Cl. B32B 31/00

(52) U.S. Cl. 156/269; 156/353; 156/577

(57) ABSTRACT

A method of fastening a first curved part to a second curved part comprises placing the second part into a specified orientation in relation to a robotically controlled tape applicator, applying two-sided adhesive tape along a non-linear path over the surface of the second part, and placing the first part into registry with the second part to adhere to the adhesive tape. A robotic tape applicator comprises a computer adapted to control a robotic arm, guide means, tensioning means and cutting means.

### CROSS REFERENCE TO RELATED APPLICATIONS

This application is a Continuation-in-Part of U.S. patent application Ser. No. 10/087,930, published as US Publication No. US 2002/0124967 which claims the benefit of U.S. Provisional Application No. 60/272,775, filed Mar. 5, 2001, which is incorporated herein by reference.

### FIELD OF THE INVENTION

This invention is in the field of fastening. In particular, it is in the field of adhering a tape or sealant to a substrate using robotics.

### BACKGROUND OF THE INVENTION

Adhesive tape and sealants finds many uses in industry. For example, a number of manufacturing operations require the placement of a plastic part over another part typically made of metal or plastic. Adhesive tape is used to adhere one piece to the other.

In any assembly line production, the goal is to produce a product with a minimum of cost. In particular, in the automotive industry, cost savings are of great importance. Time and motion studies are often performed to ensure that certain operations on an assembly line are performed in the most efficient manner possible. With practice, a worker's performance can be optimized.

In the automotive industry, it is desirable to produce a variety of vehicle models with a minimum of expense. Accordingly, standard body portions made of metal are often modified by using accessories which can be adhered to the regular vehicle body in order to create a different impression. Most often, these plastic additions are molded in non-linear shapes in order to provide visual appeal.

In a typical manufacturing operation, a metal body part is provided to a worker along with a plastic accessory which has been molded into a shape adapted to fit snugly against the surface of the body part. Normally, the worker will apply a band of an activating liquid to the body part surface where the adhesive tape is to be applied. This activator will cause the adhesive tape to stick very strongly to the body part when it has had an opportunity to cure briefly. The worker then applies a line of two-sided tape over the body part surface to which the activator has been applied. The surface of the tape facing the body part is adhesive while the outward facing surface of the tape is covered with a protective strip which prevents the protected side of the tape from sticking to the unprotected side of the tape on a roll, and allows the worker to manipulate the tape without sticking to the outward-facing side thereof. The worker is required to manoeuvre the tape along a non-linear path, and to apply sufficient pressure to the tape in order to “wet out” the tape by removing bubbles in the entrained liquid below. This requires a significant amount of manual dexterity on the part of the worker at various stages including laying down the activator, laying down the tape on top of the activator over the predetermined path, and applying appropriate pressure to the tape in order to ensure that it will be fastened securely and will perform its function adequately.

After the tape has been applied, the backing on the outward face of the tape is removed and the plastic accessory is fastened to the body part.

This entire process is somewhat intricate and time-consuming. Accordingly, it is highly labour intensive. Worker errors are costly, in terms of both additional labour costs, and delays in production.

Accordingly, it would be an advantage to reduce the time required to perform these taping operations while retaining or improving the level of precision of a skilled worker. In addition, it would be an advantage to provide a method of applying tape which is uniform, predictable and reproducible, using an apparatus which is cost-effective.

Furthermore, automotive sealants may also be applied in a similar manner in order to provide a seal between two substrates such as in the automotive industry.

### SUMMARY OF THE INVENTION

It is an object of the present invention to obviate or mitigate at least one disadvantage of previous tape or sealant application apparatus.

Accordingly, in a major aspect of the invention, a method of fastening a first curved part to a second curved part comprises placing the second curved part into a specified orientation in relation to a robotically controlled tape applicator, applying two-sided adhesive tape along a non-linear path over the surface of the second part, and placing the first curved plastic part into registry with the first part to adhere to the adhesive tape.

In a further aspect, the method further comprises applying a liquid activator over the surface of the first part along the path over which the tape is to be applied, prior to applying the tape.

In a further aspect, the liquid activator is applied with a robotically controlled activator applicator.

In a further aspect, the activator applicator forms part of the tape applicator.

In a further aspect of the invention, a robotic tape applicator comprises computer means, tape applicator means under the control of the computer means, and means to hold a work piece in registration with a tape applicator means, such that when the computer means is programmed with data respecting the shape of the work piece and the proposed path of the tape to be adhered to the work piece, the tape applicator means is adapted to apply the tape to the work piece along the path.

In a further aspect, the robotic tape applicator further comprises activator applicator means adapted to apply an activator liquid along the predetermined path prior to application of the tape.

In a further aspect, the tape applicator means comprises a tape applicator head, cutting means to slice the tape, and tape braking means adapted to hold the tape stationary during cutting.

In a further major aspect of the invention, a robotic tape applicator comprises a computer adapted to control a robotic arm according to a program, and the robotic arm comprises a roller adapted to releasably store two-sided adhesive tape, guide means to guide the tape to a tape applicator head for application to a work piece, the tape applicator head comprising a nose biased to permit reciprocal motion in a direction normal to the work piece, and cutting means integral with the tape applicator head adapted to cut the tape under the control of the computer.

In further aspects of the invention, the tape applicator further comprises tensioning means located between the roller and the nose adapted to maintain a uniform tension on the tape during tape application.

In a further aspect, the tensioning means comprises a nip roller.

In a further aspect, the tape applicator further comprises braking means adapted to releasably restrain movement of the tape.

In a further aspect, the braking means comprises a spring biased lever adapted to releasably trap the tape.

In a further aspect, the spring biased lever is a adapted to release the tape under pneumatic pressure.

In a further aspect, projections located on either side of the nose and extending beyond the leading edge of the nose a distance less than the thickness of the tape are adapted to contact the work piece while the tape is running between said projections to uniformly compress the tape during tape application.

In a further aspect, a hydraulically or pneumatically controlled piston in a compliance cylinder is adapted to maintain a constant pressure on the tape applicator head.

In a further aspect, the cutting means comprises a knife blade located within the perimeter of the tape applicator head when the cutting means is not in operation

In a further aspect, the tape applicator further comprises a pneumatic or hydraulic blade control piston to control the knife blade operation.

In a further aspect, the tape applicator further comprises a knife blade sensor adapted to detect when the knife blade is fully retracted after the tape is cut and to signal the computer so that tape application can resume.

In a further aspect, the tape applicator further comprises vacuum ports adapted to provide sites of negative pressure against which the tape can be slideably held during application of tape to the work piece.

In a further aspect, the nose of the tape applicator head comprises a smooth radius, the centre point of which radius lies along a roll axis of the robotic arm.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of the robotic tape applicator of the invention.

FIG. 2 is a partly cross-sectional side elevation view of the robotic tape applicator of the invention.

FIG. 3 is a cross-sectional elevation view of the tape applicator head of the invention.

FIG. 4 is an end elevation view in partial cross-section of the robotic tape applicator of the invention.

FIG. 5 is an opposite end elevation view in partial cross-section of the robotic tape applicator of the invention.

FIG. 6 is a schematic relationship view of the selected components of the invention.

FIG. 7 is a schematic view of a second embodiment of a robotic tape applicator.

FIG. 8 is a schematic view of a second embodiment of a tape applicator head.

FIG. 9 is a perspective view of the tape applicator head of FIG. 8.

FIG. 10 is a broken away view of the tape applicator head of FIG. 9

FIG. 11 is a schematic view of the robotic tape applicator with a tape roll loaded.

FIG. 12 is a schematic view of a second embodiment of components which interact with the robotic tape applicator.

### DETAILED DESCRIPTION

Generally, the present invention provides a method and system for applying tape or sealant to a substrate using robotics.

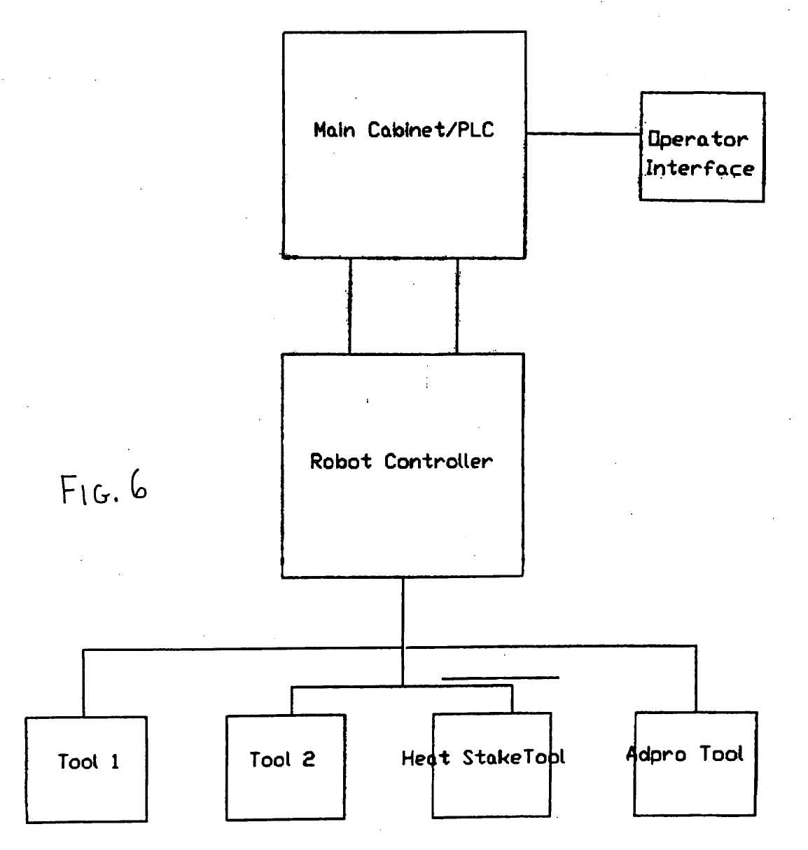

A robotic tape applicator (1) is illustrated in the attached drawings. Prior to applying tape (3), a jig (not illustrated) is prepared into which a body part is placed. The three-dimensional profile of the body part is recorded and stored in computer memory. Using appropriate programming, a path for the tape in three dimensions is determined. The tape applicator head is then oriented so that, under the control of the computer, the head follows the predetermined path. The relationship of the computer to other components of the tape applicator system are illustrated in FIG. 6.

Typically, it is beneficial to lay down a band of liquid activator which serves to make the tape head adhere to the body part strongly once it has contacted the activator and cured briefly. This activator can be applied by hand, or by an activator applicator which is adapted to follow the same path as the tape applicator head

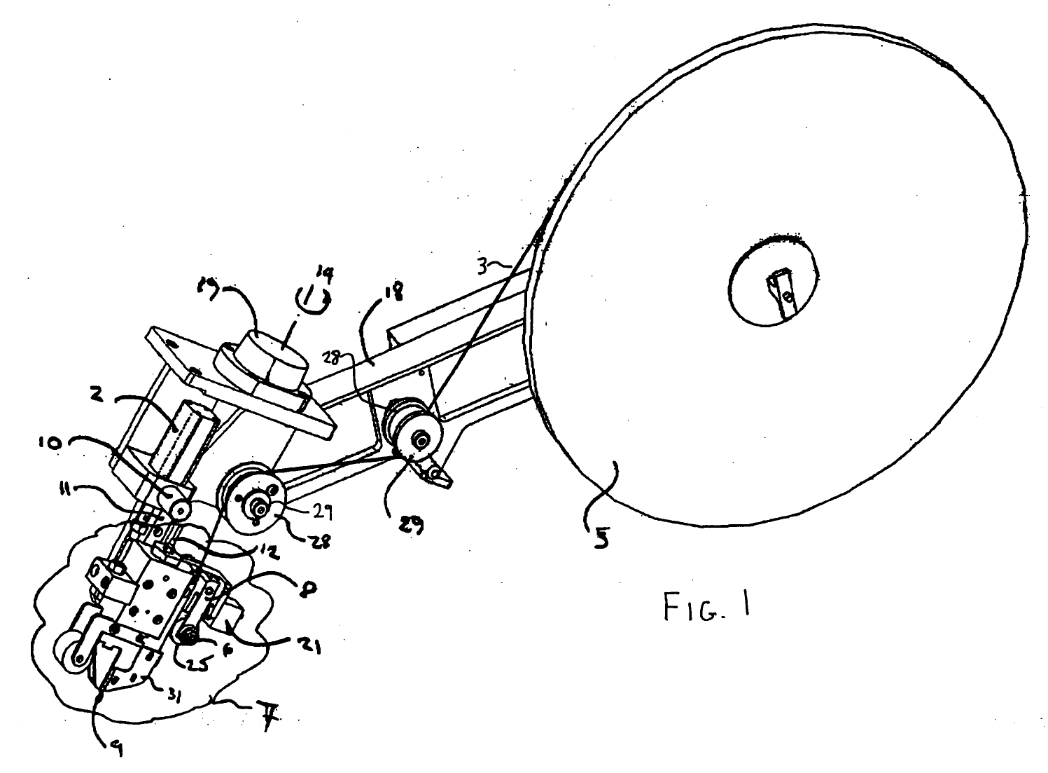

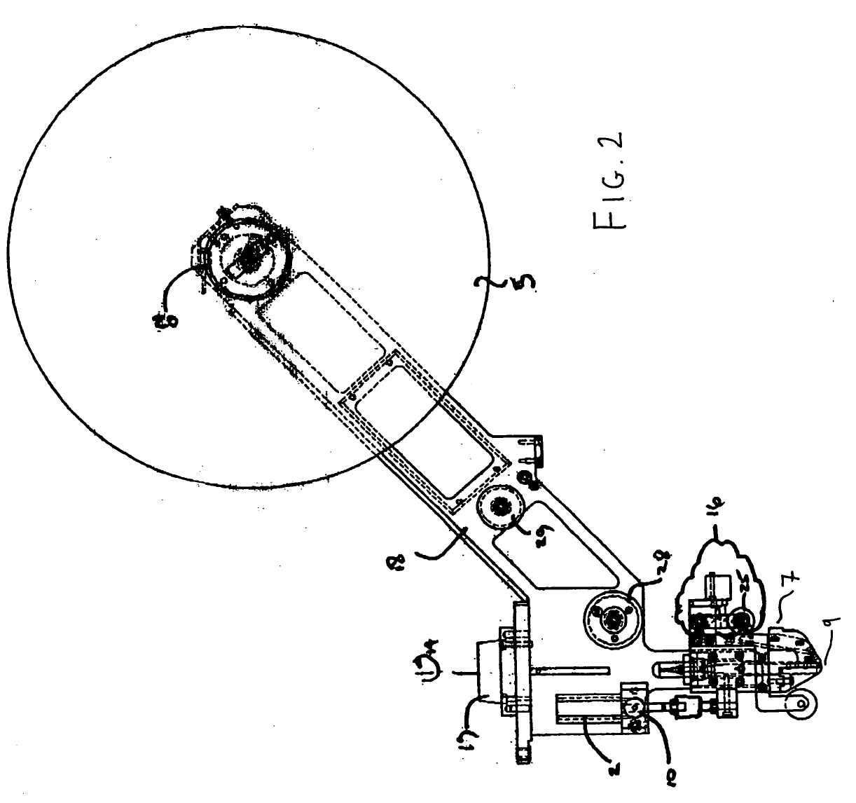

Referring to FIGS. 1 and 2, the two-sided tape (3) is rolled on a roller (5) which is mounted onto the applicator device (1) at a main bracket (18). Sensors (20) indicate the amount of tape remaining on a reel or roller. One side of the tape is adhesive while the other side is covered by a non-stick removable covering. The tape is guided along a path through the applicator device to the tape applicator head (7). Tensioning means (16) can be provided along this path in order to ensure that the tape remains under a uniform tension while it is being fed. In addition, braking means (6) can be provided in order to restrain the tape from any movement during certain operations, including cutting of the tape as further described below.

When the robotic tape applicator is placed into operation, the applicator head will proceed to the precise location dictated by its computer controller. The tape application will then begin. Pressure in the head is maintained using an application pressure cylinder (2).

The point of the tape applicator head (7) closest to the body part is referred to as the nose (9) which can be constructed as a nose piece capable of movement independently of the rest of the applicator head. In order to ensure that the tape is applied evenly without damage to the body part, the nose piece (9) is free to move reciprocally up and down in a direction normal to the surface of the work piece. In the preferred embodiment, a linear bearing (11) is provided which allows the nose piece to move vertically in relation to the surface of the body part with a minimum of friction. Irregular motion of the applicator head will introduce uneven tensions into the tape itself, so freedom of vertical motion for the applicator head is generally advantageous.

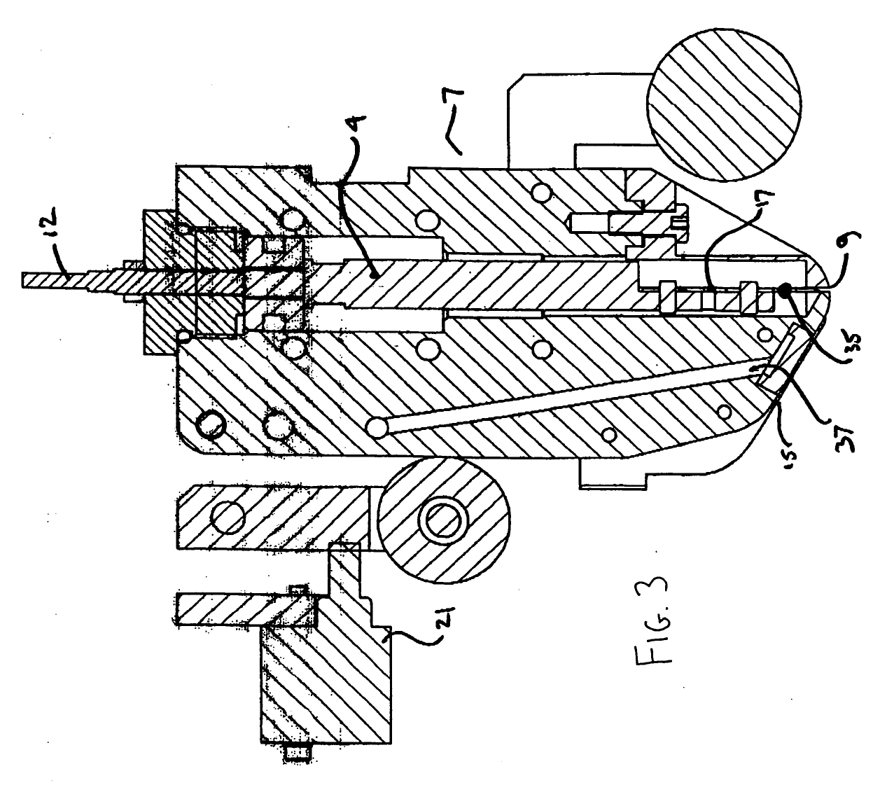

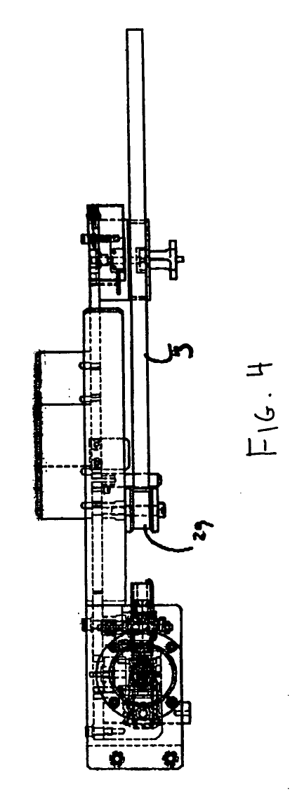

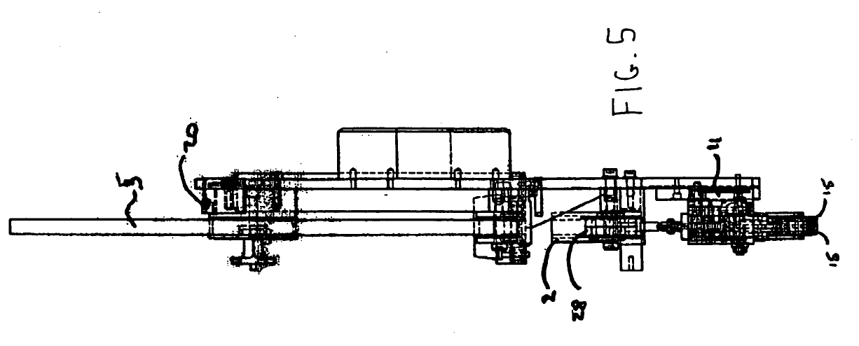

The amount of downward vertical force on the tape applicator head affects the “wet out” for removal of air bubbles from under the tape. A constant pressure is maintained on the tape applicator head by means of a compliance cylinder (2), typically regulated by hydraulic or pneumatic forces, which assists in effecting the “wet out” and allows the head to be in constant compliance with the body part. In addition, as best seen in FIGS. 3 and 5, lips or projections (15) on the side of the applicator head can be provided to ensure constant compression of the tape. In this case, the vertical dimensions of the lips between which the tape runs are slightly less than the thickness of uncompressed tape so that a defined amount of compression of the tape can be created when the lips are maintained in contact with the body part.

In order to apply tape with as much precision as possible, it is very beneficial to cut the tape while the head remains in contact with the body part so that the tape which has been applied will not be pulled away from the body part. In the preferred embodiment, as illustrated in FIG. 3, a knife blade (17) is provided which is located within the external profile of the tape applicator head. For certain body parts, it is necessary for the tape applicator head to move within a fairly narrow or confined space, so a small nose on the tape applicator head is beneficial. By incorporating the blade into the nose so that it does not protrude when the tape is in motion, the best results are achieved.

The knife blade operates under the control of a knife blade control piston (4). Referring to FIG. 1, when it is desired to cut the tape, a tape braking assembly (21) presses the tape firmly into contact with a portion of the applicator head. This locks the tape so that as the tape head pulls away from the body part, the tape does not unwind any further from the roll. Owing to the orientation of the tape as it is laid down, the braking components must be applied against the adhesive side of the tape. Accordingly, it is beneficial to coat the braking means with a non-stick surface so that it will not adhere to the adhesive side of the tape. A spring-loaded lever (8) may pivot in order to trap the tape in this assembly. An air release mechanism (10) releases the brake.

It is beneficial to maintain a constant tension on the tape during tape application. In the preferred embodiment, a nip roller (25) provides a point of constant tape tension regardless of the amount of tape on the roll. As the radius of the tape on the roll decreases, the tension on the tape can vary unless such a tape tensioning means is employed.

In order to keep the tape moving completely in line with the tape applicator head, side guides can be provided. In the preferred embodiment, crown guides (28) on the idler rollers (29) keep the tape moving in a straight line with the applicator head. These side guides can also be covered with a non-stick coating in order to prevent the tape from dragging, thus avoiding unwanted tensions. Side guide plates (31) can be located at one or more locations on the head of the applicator in order to help guide the tape.

As set out above, a spring applied/air release braking means (21) keeps the assembly locked during cutting of the tape in order to prevent tape movement. It is intended that the tape should remain in contact with the body part without any movement after it has been laid down. The compliance cylinder (2) is also locked when the braking means are applied.

If the knife is not fully retracted before the tape is applied, the tape can be cut or scraped in a unwanted manner. Accordingly, in the preferred embodiment, a knife blade sensor (12) is provided to ensure that the knife is fully retracted before tape application commences or recommences.

The shape of the nose can affect the efficiency of tape application. A smooth radius at the tip of the nose (9) prevents excess tension in the tape (3). If the centre point (35) of the radius of the nose tip (as shown in FIG. 3) is in line with the roll axis (14) of the robot arm (as shown in FIGS. 1 and 2), optimum results appear to be obtained. The roll axis of the robot is the tool point around which the robot rotates. When the centre point of the radius at the tip of the nose is in line with the roll axis of the robot, it is possible to take advantage of the circular programming functions of the robot to create extremely smooth arcing motions.

In the preferred embodiment, vacuum ports (37) in the applicator head are provided in order to assist the tape to adhere against the surface of the tape applicator head. The vacuum assists in holding the non-adhesive backing cover of the tape to the nose during the taping operation. When vacuum is being drawn, the tape is urged into contact with the tape applicator head by ambient air pressure. Although this vacuum can be turned on and off as required, every such change results in a certain amount of cycling time. Since it is beneficial to reduce cycling times, a constant vacuum can be maintained if it is of a strength which allows the tape to move along its intended path while drawing it into contact with the tape applicator head.

A tool changer (19) is used to change from one tool to another depending on the requirements of the tape application task.

In a particular example of an embodiment of this invention, a Fanuc S-5™ Robot was chosen for the activator and tape application due to the shape and size of the part to be taped. On many of the parts, a large reach combined with the ability to manipulate the tool at a complex tilt is required. The six-axis, articulated robot was programmed based on the nominal contours of the 3-dimensional mathematical part profile data. This was used to generate the basic tool path for the part. Any difference in shape due to moisture content and shrinkage was accommodated by the end of arm tooling. The robot has the capacity to store a multitude of robot paths. On the heat staking station, a five-axis Fanuc A-510™ Robot was used. Other types of robots could have been integrated according to the user's preference.

The robot end of arm tooling used in the three robot workstations consisted of:
1. 1 Activator Application Tool;
2. 10 Tape Application Heads;
3. 1 Heat Staking Head; and
4. 1 Part Pick and Place Gripper Assembly.

The tool was attached to the faceplate of the Activator Application Robot. This tool consisted of a light spring-loaded finger with a replaceable application pad. The activator was pumped to the application gun and circulated back to the activator storage tank by a back pressure relief system. This ensured that the activator was constantly being pumped to reduce the chance of nozzle clogging. The gun located at the end of arm was adapted to shut off the flow of activator at the replaceable pad and to minimize the amount of excess activator dripping off the pad.

The tape application head was adapted to handle five different tape widths. Two tape heads were dedicated to each tape width. In this way, the operator could replenish the tape supply without shutting down the process. The heads were stored in a rack that was easy for the operator to reach from outside the cell location. The heads consisted of:
1. Tape reel and sensors;
2. Tension control;
3. Application pressure cylinder and control valves;
4. Application roller;
5. Tape cut-off knife; and
6. Quick-change tooling.

The operator attached a new roll of tape to the main bracket. The tape was wound through the tension control device and onto the application roller assembly. The replenished head was placed in the tool rack above the conveyor assembly. When the control system detected that the reel was empty, the robot placed the spent head in the rack and released the quick-change tool. The robot moved to the full tape head and captured the quick-change tooling. The robot continued the tape application process as required. This same procedure was used to change between tape sizes on a part that required more than one width of tape.

During the tape application, the system was capable of negotiating curves as well as straight runs of tape. The tape application roller provided the normal force on the tape as it was applied. The tape was cut off at the end of each tape run. The knife was located just in front of the tape application roller. This allowed the tape to be kept in contact with the roller via a vacuum system. The tape was indexed to the start point using an auxiliary actuator prior to the next layout of tape.

At the Heat Stake Station, a 5-axis robot was fitted with a tool changer and two end-effectors. The heat staking and tabbing end-effector were used to automatically apply the tabs to the end of the tape runs. The tabbing material was fed in using a knurled wheel to the correct length. The heat staking iron was attached to a slide cylinder assembly. After the tab material was payed out, the heat staking iron was extended to attach the tab. A cut off knife cut the tab to the correct length. The tabs were used to remove the protective covering on the outward face of the tape.

At the Heat Stake Station, an additional end effector was supplied for sub-assembly operations. The tape liner was manually removed prior to the heat staking cell. Parts were pre-taped and placement of the parts was accomplished using the robot and suction grippers. This end-effector was only used if sub-assembly of components was required. The robot automatically dropped off the heat staking head and picked up the pick and place head.

The plastic parts were placed into a set of part fixtures. These fixtures were part specific. They were bolted to fixture carriers using doweled locations. The fixture type was verified using a set of proximity sensors. This ensured that the correct fixture was being used with the correct robot tool path.

After the part was placed into the fixture, a set of manually actuated clamps held the part firmly in place.

The fixtures were mounted to carriers that were driven by the conveyor system. The conveyor was a flexible, modular plastic chain system. A continuous loop of top running chain was chosen to allow for future expansion of the system. The pallets were located at each station using pallet stops and locator assemblies. Each carrier had an array of proximity sensor targets to verify part and fixture type. Carriers were supported by pallet “Pucks” that sat on the conveyor belt during transport from one station to the next. Each carrier had two pucks that pivoted as the fixture was driven around the corners. Pallet carriers were located at a convenient height for operator loading/unloading.

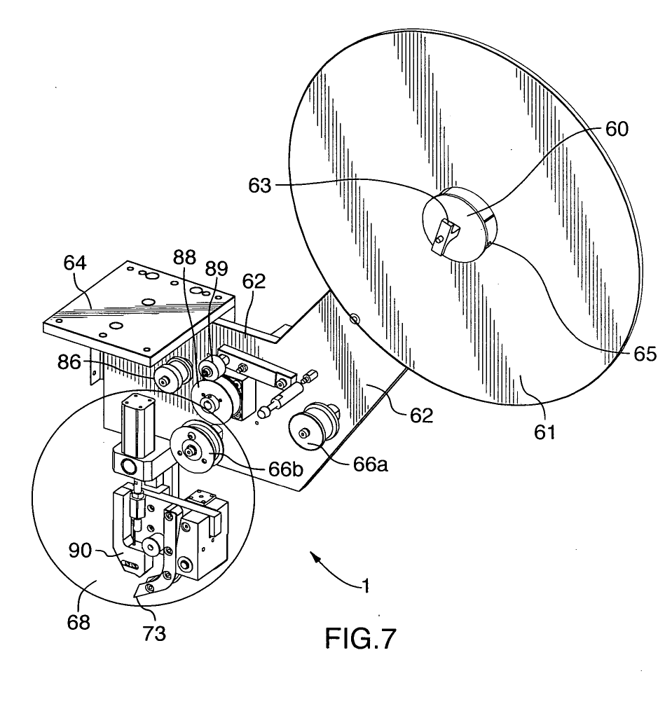

Turning to FIG. 7, a second embodiment of a robotic tape applicator (1) is shown. In this embodiment, the robotic tape applicator (1) comprises a tape hub (60) which holds a roll of tape (61) to be applied to a substrate. The tape hub (60) includes an integrated brake and retainer (63) along with a sensor, located centrally on the hub which assists in monitoring the amount of tape left on the roll. Therefore, if a substrate requires a length of tape which is longer than the tape remaining on the roll, a robot may change the robotic tape applicator (1) prior to commencing the tape application process in order to ensure that only one piece of tape is used for each taping application process rather than two separate pieces of tape. The tape may be one or two-sided adhesive. In the case of a two-sided adhesive roll of tape, one of the sides includes a removable, non-stick tape backing so that the tape does not stick together when in the roll format as well as to the parts of the robotic tape applicator (1). In the case of the one-sided adhesive tape, due to the adhesive nature of the tape, the non-adhesive side of the tape also has a removable, non-stick backing so that the adhesive side of the tape does not adhere to the non-adhesive side of the tape. The tape hub (60) is connected via a main bracket (62) to a robot interface plate (64). The robot interface place (64) allows a robot to replace the robotic tape applicator (1) with another robotic tape applicator, when necessary.

Connected to the main bracket (62) are a pair of idler rollers (66a and 66b) which assist in guiding an end of the tape (61) from the tape hub (60) to a tape applicator head (68).

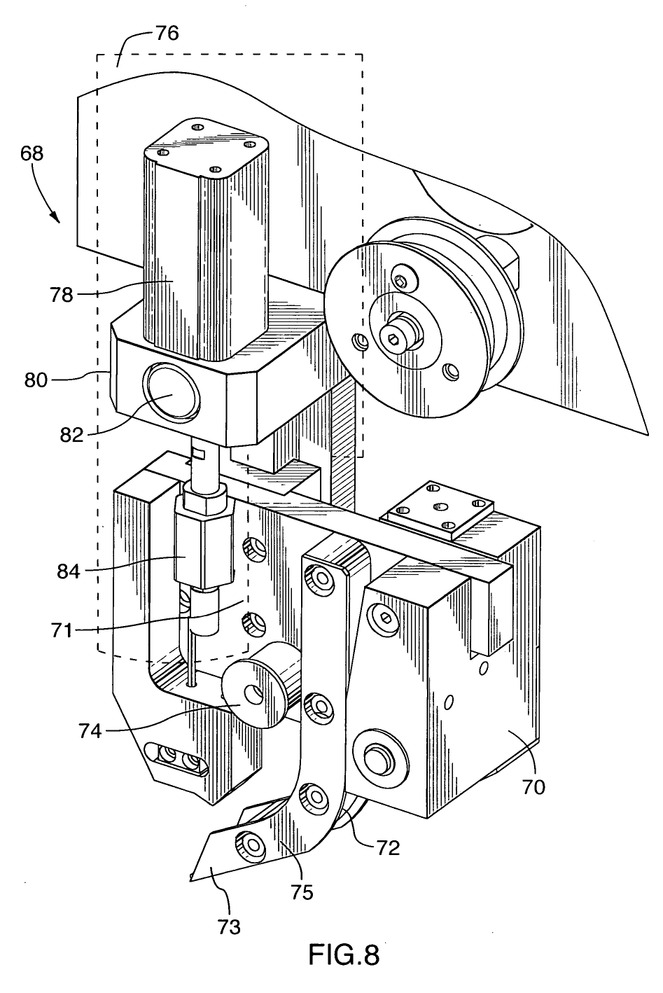

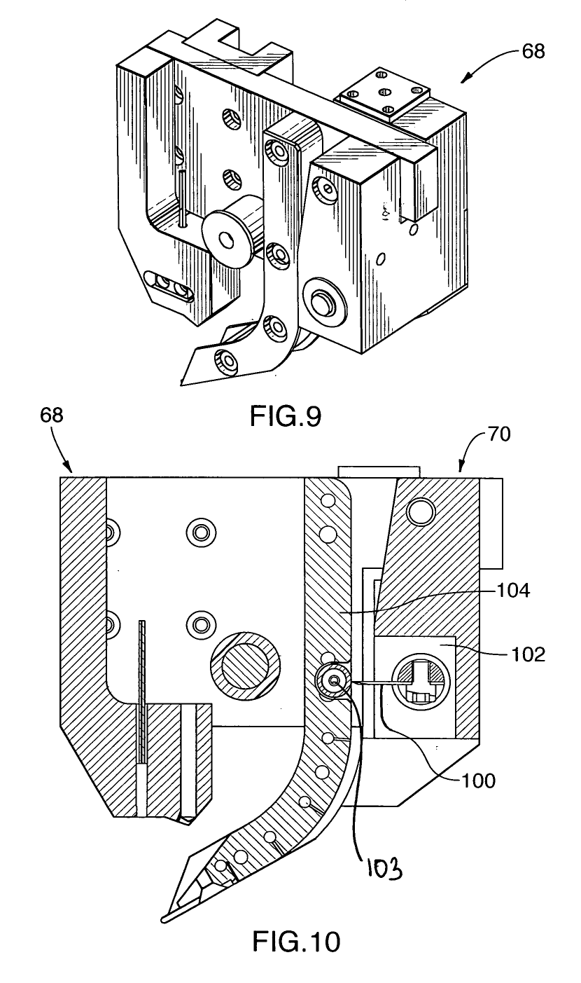

As more clearly shown in FIG. 8, the tape applicator head (68) comprises a tape applicator head back plate (71) having a side cutting assembly (70) along with a tape guide (72), having side guides (75), connected to a nose (73) where the tape is applied to the substrate. Although the nose (73) is seen as a sharp end, the height of the tape being applied is greater than the height of the side guides such that the nose (73) does not contact the substrate during the tape application process.

The cutting assembly is seen as a side cutting assembly and comprises a blade movable through the tape in a direction not substantially towards the substrate and is more clearly shown in FIG. 10.

The tape applicator head (68) also comprises a backing idler roller (74) which assists in guiding the removable tape backing back up through the tape applicator head to a disposal system. The tape applicator head (68) also comprises a compliance cylinder assembly (76) which operates as a means to effect “wet out” and allows the tape applicator head (68) to remain in contact with the substrate during the tape application process.

The compliance cylinder assembly (76) comprises an air cylinder (78) connected to a mounting block (80) housing a brake (82). The cylinder assembly (76) also comprises an alignment coupler (84). Although shown as a pneumatic cylinder assembly, the cylinder assembly may also be regulated by hydraulic forces. The cylinder assembly (76) allows for the tape application head (68) to move in a vertical position while the tape is being applied. As will be understood, during the tape application process, the path taken by the applicator head (68) is predetermined and stored in a memory or processor associated with the robot controlling the robotic tape applicator (1). Although the predetermined path may be three-dimensional in nature, it does not account for the case where are minor bumps and inconsistencies with the surface of the substrate. The compliance cylinder (76) allows for tape applicator head (68) to comply with these inconsistencies so that the tape applicator head (68) does not become damaged during the tape application process.

The robotic tape applicator (1) further comprises an outfeed roller (86) which assists in guiding the removable tape backing from the tape after it has been applied. A tape drive unit (88), also located on the main bracket (62), is a motorized unit which assist in drawing the removable backing off of the applied tape in order to remove it and transport it to the disposal system. The speed of the motor is linked to the speed that the robot is operating at so that the tape application process is in sync with the control of the robot.

A pinch roller assembly (89) pinches the tape backing between the rollers of the assembly (89) and the tape drive unit (88) to create friction between the tape backing and the tape drive unit (88) so that when the drive unit rotates, the tape backing is pulled through the application head (68). Although not shown, there is a cut off knife, preferably located on the disposal system, which cuts the removable backing so that it may be disposed.

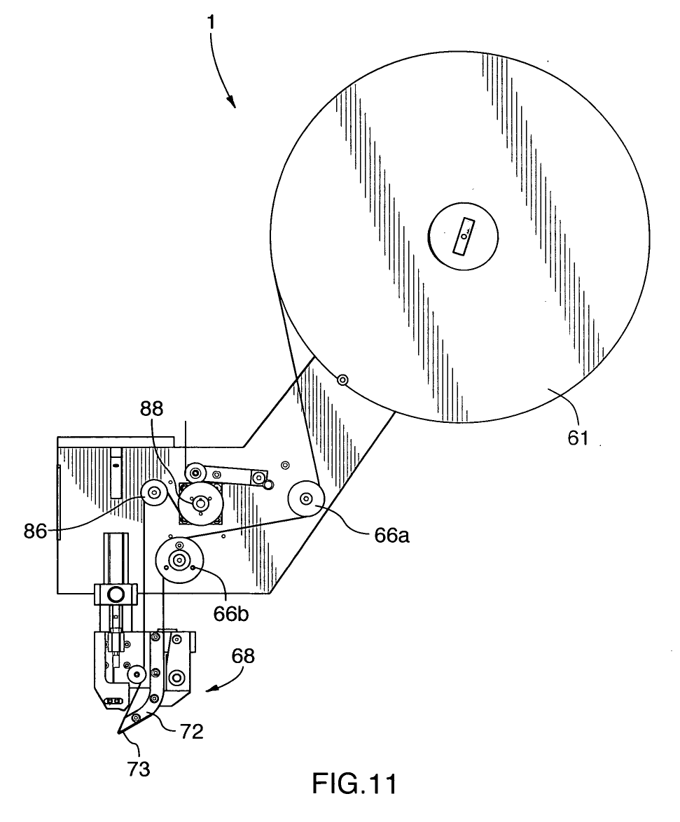

Prior to operation as shown in FIG. 11, which is a schematic diagram of how the tape travels through the robotic tape applicator, in order to connect the tape with the disposal system, the tape is hand woven through the robotic tape applicator.

The tape is initially located at the tape hub with a loose, leading end of the tape hanging from the roll. The leading edge of a roll of tape is pre-woven by an operator past the idler rollers to the tape application head where the end of the tape is then woven down between the tape guide and the cutting assembly and then placed in the tape guide between the side walls so that it rests within the tape guide. The tape is then drawn back up the tape application head, past the outfeed idler roller to the tape drive, where it is then woven and connected to the disposal system as shown.

In operation, a robotic tape applicator (1) is selected by a robot and slotted into position so that the tape application process may commence. Once the robotic tape applicator is slotted, the tape drive unit (88) initiates and starts to draw the tape along its rollers and the tape application process commences.

As the tape travels along the rollers, it is then guided down between the side cutting assembly (70) along the tape guide (72) to the nose (73). As the tape applicator head (68) travels along the predetermined path, the tape is laid down against the substrate and the removable tape backing removed from the tape (at the nose of the tape applicator as the tape is laid down) and drawn back along the outfeed roller (86) and the tape drive unit (88) by the tape drive unit and then sent to the disposal system, preferably a vacuum-like system.

As will be understood, the path by which the tape is to be adhered to the substrate is predetermined and stored in a memory/processor which is associated with the robot. Since the path is predetermined, the length of tape required is also known and programmed into the software executing on the processor. Therefore, after the required length of tape has passed by the side cutting assembly, a quick cut is performed by a knife blade within the assembly. The cutting is generally controlled by the software. The cut is such that only the adhesive tape is cut and the removable backing remains intact, so that the tape may continue traveling towards the nose of the tape applicator head (68). After the end of the tape (which has just been cut) has been applied to the substrate, the new cut end rests at the nose of the tape applicator head for the next substrate. Sensors are located within the side cutting assembly, near the knife blade to sense a leading edge for a new roll of tape when one is mounted on the tape hub (60). By having a side cutting assembly, the knife does not damage the substrate and since the distance between the nose and the side cutting assembly is known, the cut is performed early and the remainder of the tape laid down. This also allows for faster application times since new substrates may be immediately placed for tape application after the tape has been applied to the previous substrate. This will be described in more detail with respect to FIG. 10.

A second sensor (90), located at the nose of the tape applicator head, verifies that the tape has been applied correctly and that there are no bumps in the adhesive.

Turning to FIG. 10, a broken away view of the tape applicator head (68) is shown. As can be seen in the Figure, the cutting assembly (70) comprises a knife blade (100), in a knife housing (102), for cutting the tape so that it may be laid down on the substrate. After the sensors have sensed that the required length of tape has passed by the cutting assembly, the knife blade is protracted out of its housing and makes a cut. The cut is precisioned so that the tape backing does not get cut but continues to travel along the rollers (even after the tape is laid down) and returned to the disposal system. After the cutting has been performed, the knife blade is then retracted back into the knife housing.

The cutting assembly also includes a backing roller (103) which provides a low friction surface over which the backing of the tape may travel in order to prevent stretching in the tape. In this manner, while the tape is traveling through the tape applicator head, the tape does not get stretched and therefore lose any of its elasticity and its adhesiveness.

As the tape travels along the tape guide between the sensor and the cutting assembly, signals are transmitted to the processor associated with the robot to keep track of the amount of tape which has been laid down on the substrate.

After the robot/processor has sensed that the required amount of tape has passed by the side cutting assembly, a signal is transmitted to a cylinder (not shown) which is generally located adjacent the cutting assembly. The signal causes the cylinder to move in a horizontal position towards the knife housing, causing the knife blade to protract out of the housing, towards the tape. The movement of the cylinder causes a spring within the housing to push the knife blade out at a 45 degree angle above the horizontal where it contacts the tape. A rack and pinion assembly, located above the knife housing, then causes the knife blade to travel downwards at a speed equal to the speed of the tape. The knife blade contacts the tape through an angle of 90 degree (to a point 45 degrees below the horizontal where it removes itself from contact with the tape and the cut is performed. The knife blade is then retracted back into the housing and the cylinder returned to its original position to await the next signal.

The cut performed by the knife is better known in the art as a rotary cut such that there is only one point of contact between the knife blade and the tape during the cutting process. Therefore, the entire cutting process is controlled by the software executing on the processor.

As the cut tape continues to travel along the tape guides, the tape is laid down at the nose onto the substrate and only the tape backing passes by the outfeed idler roller and the tape drive for disposal by the disposal system.

Furthermore, the amount of tape that has been laid down is determined by the processor which determined the speed at which the tape is being laid down and calculates the amount of tape required so that it calculates the length of time for the tape to be applied before the knife blade makes its rotary cut. The equation may be seen as follows:
Time to Cut=(Length of tape required)/(speed of tape being applied)

Therefore after the tape has been traveling and laid down on the substrate for the required amount of time, the signal is transmitted to the cylinder to protract the knife in order to cut the tape.

Furthermore, as described above, when the tape roll, runs out, it is necessary to replace the used roll, with another tape toll. A signal is then transmitted from the tape hub to the processor indicating the need for replacement. The robot then interacts with the robotic interface plate (which generally includes a quick change tool as described above) to remove the current robotic tape applicator with another one.

Although described above as a tape applicator head, it will be understood that the applicator head may also be used to apply sealants, such as automotive sealants to a substrate as well. As well, the substrate is preferably an automotive component but may be any other component which requires either tape or sealant to be adhered.

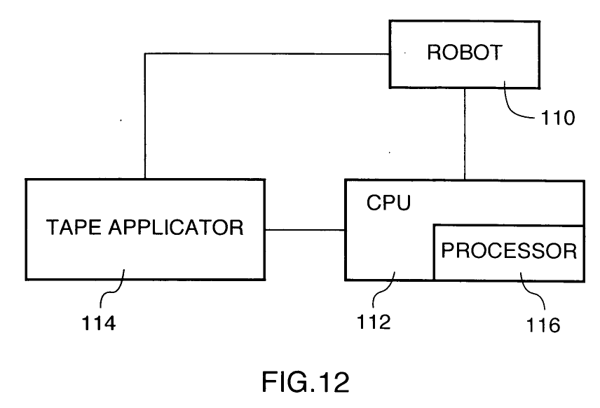

Turning to the FIG. 12, a schematic diagram is shown of how the robotic tape applicator interacts with the processor in order to apply tape to a substrate. The operation of the robotic tape applicator 114 is controlled by the computer 112 (associated with the robot 110). Within the computer is a processor 116 which executes the software required to control the cylinder of the side cutting assembly. The computer also controls the robot to change tape application heads and rolls of tape when it is sensed that there is not enough tape on the roll to complete the nest application.

The computer may be located within the robot as well or may be a separate entity to control the robot.

Although the invention has been described in terms of a preferred embodiment, other embodiments of the invention will be apparent to those skilled in the art of robotics and fastening without departing from the scope of the invention which is defined solely by the claims appended hereto.

The above-described embodiments of the present invention are intended to be examples only. Alterations, modifications and variations may be effected to the particular embodiments by those of skill in the art without departing from the scope of the invention, which is defined solely by the claims appended hereto.

1. A tape application head comprising:
means for receiving tape from a tape supply;
means for applying said tape to a substrate when said tape application head is moved along said substrate; and
a cutting assembly for cutting said tape after a predetermined amount of said tape has been applied to said substrate, said cutting assembly comprising a blade movable through said tape in a direction not substantially towards said substrate.

2. The tape application head of claim 1 further comprising means for driving said tape through said tape application head.

3. The tape application head of claim 2 wherein said means for driving is a tape drive unit.

4. The tape application head of claim 1 further comprising an outfeed roller for guiding a removable tape backing to a disposal system after said tape has been applied.

5. The tape application head of claim 1 further comprising at least one guide roller for guiding said tape from said cutting assembly to said means for applying.

6. The tape application head of claim 1 wherein said means for applying tape to said substrate is a nose.

7. The tape application head of claim 1 wherein said side cutting assembly further comprises:
means for cutting said tape; and
at least one sensor for monitoring the amount of tape which has been laid down on said substrate;
wherein after said at least one sensor determines the correct amount has been laid down, said sensor transmits a signal to said means for cutting said tape to cut said tape.

8. The tape application head of claim 7 wherein said means for cutting said tape is a knife blade.

9. The tape application of claim 1 wherein said guide roller is an idler roller.

10. The tape application head of claim 1 further comprising a compliance cylinder assembly.

11. The tape application head of claim 10 wherein said compliance cylinder assembly comprises:
an air cylinder;
a compliance brake;
a brake mounting block, housing said compliance brake; and
a compliance alignment coupler.

12. A robotic tape applicator comprising:
a means for mounting a roll of tape;
a tape application head;
means for guiding the tape from the means for mounting the roll of tape to the tape application head;
the tape application head comprising:
means for receiving tape from a tape supply;
means for applying said tape to a substrate when said tape application head is moved along said substrate; and
a cutting assembly for cutting said tape after a predetermined amount of said tape has been applied to said substrate, said cutting assembly comprising a blade movable through said tape in a direction not substantially towards said substrate.

13. The robotic tape applicator of claim 12 further comprising:
a tape drive unit for drawing said tape from said means for applying tape.

14. The robotic tape applicator of claim 13 wherein said tape drive unit is motorized.

15. The robotic tape applicator of claim 12 further comprising an outfeed roller for guiding a tape backing to a disposal system.

16. The robotic tape applicator of claim 12 wherein said means for applying tape to said substrate is a nose.

17. The robotic tape applicator of claim 12 wherein said side cutting assembly further comprises:
means for cutting said tape; and
at least one sensor for monitoring the amount of tape which has been laid down on said substrate;
wherein after said at least one sensor determines the correct amount has been laid down, said sensor transmits a signal to said means for cutting said tape to cut said tape.

18. The robotic tape applicator of claim 12 wherein said means for cutting said tape is a knife blade.

19. The robotic tape applicator of claim 12 wherein said guide roller is an idler roller.

20. The robotic tape applicator of claim 12 further comprising a compliance cylinder assembly.

21. The robotic tape applicator of claim 20 wherein said compliance cylinder assembly comprises:
an air cylinder;
a compliance brake;
a brake mounting block, housing said compliance brake; and
a compliance alignment coupler.

22. A method of applying tape onto a substrate comprising the steps of:
positioning said substrate in a predetermined position, relative to a robotically controlled tape applicator; and
applying said tape, via said robotically controlled tape applicator, to said substrate.

23. The method of claim 22 wherein said step of applying said tape is along a non-linear path.

24. The method of claim 22 wherein said step of applying said tape comprises the step of passing the tape past a tensioning means and a cutting means.

25. The method of claim 24 wherein said tensioning means is a nip roller.

26. The method of claim 24 wherein said cutting means is a knife.

27. A method of applying a length of tape to a substrate comprising the steps of:
positioning the substrate in a predetermined position; and
applying tape via a robotically controlled tape applicator, said robotically controlled tape applicator comprising:
a means for holding said roll of tape;
a tape applicator head; and
at least one guide roller for guiding said tape from said means for holding said roll of tape to said tape applicator head.

28. The method of claim 27 wherein said step of applying tape comprises the steps of:
guiding an end of said tape from said means for holding said roll of tape via said at least one guide roller to said tape applicator head;
laying said tape on said substrate along a predetermined path; and
cutting said tape after said tape has been laid down against said substrate along said predetermined path.

29. The method of claim 28 wherein said step of laying said tape further comprises the step of providing a vacuum to provide sites of negative pressure against which the tape is slideably held.

30. The method of claim 27 wherein said means for holding said roll of tape is a roller.

31. The method of claim 27 wherein the substrate is an automotive part.

32. The method of claim 27 wherein said tape applicator head comprises a knife for cutting the tape.

33. The method of claim 27 wherein said tape applicator head further comprises means for applying tension to said tape.

34. The method of claim 33 wherein said means for applying tension is a nip roller.

35. The robotic tape applicator of claim 4 wherein the disposal system is a vacuum system.
